(19) United States
(12) Patent Application Publication
(10) Pub. No.: US 2004/0246723 A1
(43) Pub. Date: Dec. 9, 2004

(54) Flexible conduit light-motion sensor assembly

(76) Inventors: Brian Graves, San Diego, CA (US); Poho Shyu, San Diego, CA (US)

Correspondence Address: SACHNOFF & WEAVER, LTD., 30 SOUTH WACKER DRIVE, 29TH FLOOR, CHICAGO, IL, 60606, US

(21) Appl. No.: 10/745,229

(22) Filed: Dec. 23, 2003

Related U.S. Application Data
(60) Provisional application No. 60/470,834, filed on May 15, 2003.

(51) Int. Cl. F21V 21/00

(52) U.S. Cl. 362/276; 362/287; 362/427

(57) ABSTRACT

A light-motion sensor assembly, for use with a light, has a base plate. A light fixture is coupled to the base plate. A motion sensor has a housing for retaining one or more sensors for converting light signals into one or more electronic signals. A flexible conduit couples the motion sensor housing to the base plate, and the flexible conduit permits selective orientation of the motion sensor in various positions relative to the light fixture.

### CROSS REFERENCE

This application claims priority to the Provisional Patent application, Application No. 60/470,834, filed on May 15, 2003, entitled “Flexible Conduit Light-Motion Sensor Assembly.”

### FIELD OF THE INVENTION

The invention relates to a light fixture and motion sensor assembly. More particularly, the invention relates to an outdoor light fixture coupled to a motion sensor by a flexible conduit such that the sensor may be placed at various orientations relative to the light fixture.

### BACKGROUND OF THE INVENTION

Light fixture-motion sensor assemblies are well known. Typically, the sensor is coupled to the light fixture such that the zone of detection and orientation of the sensor relative to the light fixture are limited. Therefore, there is a need for a light fixture-motion sensor assembly that permits adjustment of the sensor at various positions relative to the light fixture.

### SUMMARY OF THE INVENTION

The present invention is directed to a light-motion sensor assembly for use with a light, comprising a base plate; a light fixture coupled to the base plate; a motion sensor having a housing for retaining one or more sensors for converting light signals into one or more electronic signals; a lens supported by the motion sensor housing for directing infrared to said sensors; and a flexible conduit coupling the motion sensor housing to the base plate, wherein the flexible conduit permits selective positioning of the motion sensor in various orientations relative to the light fixture.

### BRIEF DESCRIPTION OF THE DRAWINGS

The features and inventive aspects of the present invention will become more apparent upon reading the following detailed description, claims, and drawings, of which the following is a brief description:

FIG. 1 is perspective view of a light and motion sensor assembly formed in accordance with the teachings of this invention.

FIG. 2 is a perspective view of the light and motion sensor assembly shown in FIG. 1, wherein the motion sensor has been re-positioned relative to the light fixture.

### DETAILED DESCRIPTION OF THE INVENTION

A detailed description of the present invention is described herein with reference to the accompanying drawing figures. Terms of reference such as “central,” “bottom,” “front,” “back,” or “side” may be used to facilitate an understanding of the present invention in view of the accompanying figures. The identified reference terms or other similar terms are not intended to be limiting, and one of ordinary skill in the art will recognize that the present invention may be practiced in a variety of spatial orientations without departing from the spirit and scope of the invention.

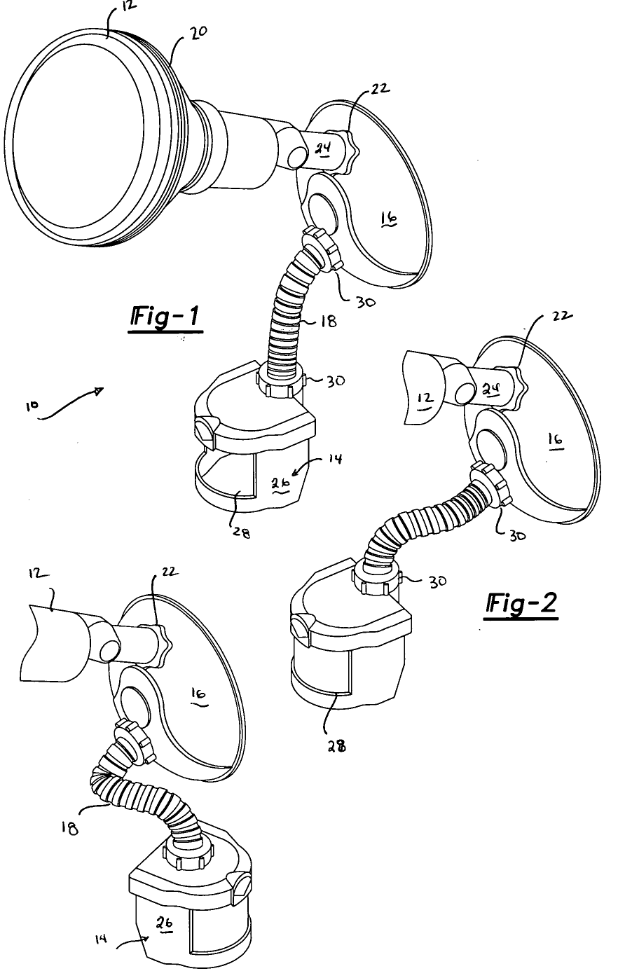

FIG. 1 shows an outdoor light fixture and motion sensor assembly 10 formed in accordance with the teachings of this invention. The assembly 10 includes a light fixture 12, a motion detector 14, base plate 16 and a flexible conduit 18.

As shown in FIG. 1, the light fixture 12 includes a housing 20, fastener 22 and a coupling shaft 24. The housing 20 is adapted to retain an illumination device such as an electrical light. The housing 20 may be any type of housing that is commonly known and used in the lighting industry. More particularly, the housing 20 may be specifically designed for indoor or outdoor lighting. Further still and more specifically, the housing 20 will be of the type used in light-motion sensor assemblies. Since the design of light fixture housings are well known to those of ordinary skill in the art no further description is deemed necessary.

The housing 20 may be constructed of ceramic, metal, plastic or a combination of ceramic, metal or plastic. The housing 20 should provide sufficient durability for indoor or outdoor use. The choice of material selected may turn on the environment in which the assembly 10 will be used.

The housing 20, as is known in the lighting industry, includes a support structure (not shown) for receiving at least one illumination device such as a light bulb. The housing, also as is known in the industry, supports electrical circuitry that permits the illumination device to receive electrical power.

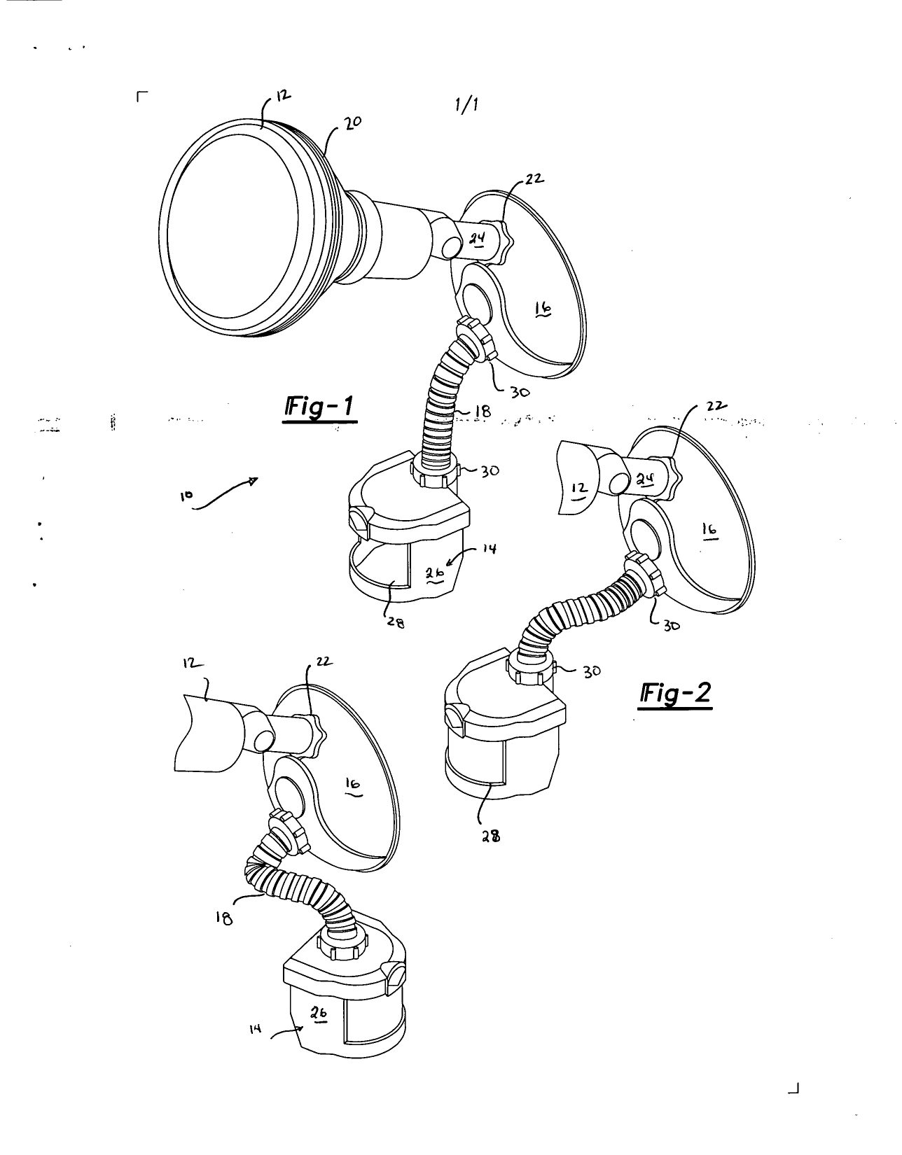

Also shown in FIG. 1, the motion sensor 14 includes a housing 26. The housing 26 is of the type used in the lighting industry for indoor or outdoor light and motion sensor assemblies. The design and construction of motion sensors and motion sensor housings, particularly those used with lighting devices, are well known to those of skill in the art. It is known that the housing 26 may be formed of a ceramic plastic, metal or a combination of ceramic, metal or plastic materials. The housing 26 also includes an internal compartment for housing electrical circuitry and one or more infrared sensors. As best seen in FIGS. 1 and 2, the housing 26 also includes an opening 28 for supporting a lens (not shown). The lens may be secured within the opening 27 using known techniques.

The lens may be a Fresnel lens or any other lens that is used in conjunction with light and motion sensor assemblies. As known to those of ordinary skill in the art, lens directs infrared light to sensors retained within the housing 26.

The design and construction of the sensors (not shown) are well known to those of skill in the art. The sensors produce an electrical or electronic signal that corresponds to the amount of infrared light detected. The signal in turn is processed by electronic circuitry (not shown) to determine if motion has occurred. There are a number of ways in which the circuitry used to detect motion may be designed, and these techniques are well known to those of ordinary skill in the art.

As best seen in FIGS. 1 and 2, the assembly 10 also includes a flexible conduit 18. The flexible conduit 18 may be selectively configured and positioned in various orientations, and may be formed of metal or plastic. For example, the flexible conduit 18 may be flexible steel tubing of the type available from VIMCO, Inc., 1356 Route 78, Java Center, N.Y. 14082, and sold under the designation Flexible Arms (Goosenecks) or Flexible Steel Tubing. The flexible conduit 18 may also be a Standard Convolution, Standard Wall conduit available from Joslyn Sunbank Company, LLC, 1740 Commerce Way, Paso Robles, Calif. 93446. Further still, the flexible conduit 18 may comprise gooseneck conduit/tubing or flexible tubing of the type typically used in the lighting industry.

As best seen in FIGS. 1 and 2, the flexible conduit 18 is coupled to the base plate 16 using mechanical fasteners. For example, each end of the flexible conduit 18 may be fitted with a collar 30. The collar 30 may be press-fitted on the end of the flexible 18. The metal collar 30 provides a mounting termination for attaching the flexible conduit 18 to the base plate 16 and the sensor housing 26. Alternatively, the collar 30 could be affixed to the base plate 16 and motion sensor housing 26 using an adhesive, welding or other similar techniques.

As best seen in FIG. 1, the base plate 16 provides a common connection point for the light fixture 12 and the sensor 14. The base plate 16 is of a type used in conjunction with light-motion sensor assemblies. The design and construction of these types of base plates is generally known to one of ordinary skill in the art. The base plate 16 may also include an internal compartment adapted to house electrical circuitry for the light fixture and the motion sensor.

As best seen in FIG. 1, the light-motion sensor assembly is formed by attaching the housing 20 of the light fixture 12 and the housing 26 of the motion sensor 14 to the base plate 16. The housing 20 of light fixture 12 is coupled to the base plate 16 by the coupling shaft 24 using known techniques. As best seen in FIG. 1, the housing 20 may be secured to the support shaft 24 by a mechanical fastener 22. The fastener 22 may be adapted to permit the housing to pivot or rotate about the connection point. This arrangement permits the housing 20 to be placed in various orientations. Alternatively, the fastener 22 may fixedly join the housing 20 to the coupling shaft 26 so that the housing 20 is not movable or rotatable. The mechanical fastener 22 may be a bolt, ball and socket joint or any other known mechanical fastener that permits fixed or rotational coupling of one device to another.

The opposite end of the coupling shaft 24 is coupled to the base plate 16 using known techniques. For example, a mechanical fastener (not shown) may be used or the shaft may be support threads that mate with threads supported by an opening formed in the base plate 16. Various methods for coupling the shaft 24 to the base plate 16 are known to those of ordinary skill in the art.

The flexible conduit 18 is coupled to the base plate 16 using mechanical fasteners, adhesive bonding, welding techniques or other known techniques that will permit the flexible conduit 18 to be oriented in various positions relative to the light fixture 12 yet remain securely fastened to the base plate 16. As best seen in FIG. 2, the flexible conduit 18 permits the light sensor 26 to be positioned in various orientations relative to the light fixture 12.

While the invention has been described with reference to an exemplary embodiment, it will be appreciated that numerous variations, modifications, and alternate embodiments are possible, and accordingly, all such variations, modifications, and alternate embodiments are to be regarded as being within the spirit and scope of the invention. Therefore, the following claims should be studied to determine the true scope and content of the invention.

What is claimed is:

1. A light-motion sensor assembly for use with a light comprising:
a base plate;
a light fixture coupled to the base plate;
a motion sensor having a housing for retaining one or more sensors for converting light signals into one or more electronic signals; and
a flexible conduit coupling the motion sensor housing to the base plate, wherein the flexible conduit permits selective orientation of the motion sensor in various positions relative to the light fixture.

2. The light-motion sensor assembly of claim 1, wherein the flexible conduit is plastic.

3. The light-motion sensor assembly of claim 1, wherein the flexible conduit is metal.

4. The light-motion sensor assembly of claim 1, wherein the motion sensor housing supports at least one lens for directing an electrical signal to the sensors.
